(19) United States
(12) Patent Application Publication
(10) Pub. No.: US 2023/0147564 A1
(43) Pub. Date: May 11, 2023

(54) System And Method For Conducting A Publicly Auditable Election

(71) Applicant: Carey Robert Briggs, Rancho Palos Verdes, CA (US)

(72) Inventor: Carey Robert Briggs, Rancho Palos Verdes, CA (US)

(21) Appl. No.: 18/053,382

(22) Filed: Nov. 8, 2022

Related U.S. Application Data
(60) Provisional application No. 63/276,669, filed on Nov. 8, 2021.

(51) Int. Cl. G06Q 50/26; H04L 9/08

(52) U.S. Cl. CPC G06Q 50/26; H04L 9/0825; G06Q 2230/00

(57) ABSTRACT

The present invention comprises a method of conducting a publicly auditable election. The invention allows an elector to verify their ballot has been counted towards the result of an election in the manner in which it was cast. The elector is capable of cryptographically proving if their ballot has been altered or deleted. Any interested individual or entity is capable of auditing the election using an anonymized database of published ballots.

### FIELD OF THE INVENTION

The present invention generally relates to information security. More particularly, the invention relates to secure elections which can be audited by any interested party.

### BACKGROUND OF THE INVENTION

When discussing security in the design of an election system, four characteristics gain focus: Anonymity, severability, equality, and trust.

For an election system to be anonymous. no person shall be able to deduce how any elector voted. This is largely a check against intimidation and/or suppression of the vote. That is to say, an individual or entity hostile towards a candidate or policy cannot use completed ballots to search for electors who cast ballots for said candidate or policy (with the implied intent of retribution).

For an election system to be severable, no elector shall be capable of providing proof of how they voted (each ballot is severed from the elector). This is largely a check against bribery and coercion, similar to the anonymity characteristic. Anonymity and severability, jointly, prevent bribery and coercion from being viable attack vectors against an election's integrity.

For an election system to be equal, each elector must have exactly one counted vote according to their independent will, or zero if abstaining voluntarily. In the United States, law provides for equal representation. No elector is afforded larger representation than any other elector at the ballot box, unless an elector voluntarily chooses to abstain from casting their ballot. Attacks against this characteristic commonly include destroying valid ballots, changing valid ballots, or adding invalid ballots.

For an election system to be trustworthy, there must be a method by which any interested party can audit and verify the results of any election. Confidence in the propriety of an election must not require faith in other people.

One functional example of a secure election system is the traditional ballot box. A chosen box with a narrow slit in its top is demonstrated to be empty in plain view of the electorate. The box is then closed, and identical slips of paper are distributed to each member of the electorate. Each participating member then secretly marks a vote on their slip of paper and folds it, concealing the ballot from view. Each elector then inserts their paper into the ballot box through the slit at the top, in full view of the electorate. Once all electors have added their paper to the box, the box is shaken to mix the votes. The box is then opened and ballots are counted in plain view of the electorate. This method satisfies all four characteristics defined above.

One substantial shortcoming of the ballot box is its scalability. The ballot box process is only viable for an electorate small enough to satisfactorily observe the entire process. Contemporary elections routinely handle tens of thousands to millions of electors. As a result the process is parallelized and distributed. Ballots are transported from local polling stations to tabulation centers for counting. A large portion of the ballot process is conduced out of view of the electorate and locked within the source code of black-box computational devices. Once a ballot is surrendered, an elector has no provable means of verifying said ballot was counted accurately and fairly towards the results of an election.

There is an inherent trade-off between trust and severability. There is no known method of employing a system that is completely open, verifiable, and also severs an elector from their ballot. In implementations which value equality above severability, the severability requirement can be compromised to result in a system where the amount of faith required falls to zero. A provisional patent related to this one was previously filed describing a system and method designed to satisfy anonymity and severability, while still requiring a small degree of faith in private, third-party auditors. A need still exists in the field for a method of conducting an election in which all data is open and requires no faith in private third-parties.

It is instructive to review ideal election system characteristics in reference to existing systems.

The anonymity requirement can be easily satisfied by not linking personally identifiable information to a ballot. For example, no elector's name is printed on said elector's ballot. This requirement is ballot-facing. Specifically—no person with access to the ballots can select a ballot and discern which elector cast said ballot. If an elector randomly chooses a unique number and writes said number on their ballot, then retains the only copy of said number as a form of receipt—the presence of the unique number cannot, on its own, be used to identify the elector who cast the ballot. Paper ballot systems typically satisfy this requirement as no identifiable information is retained on the ballot. Most deployed electronic ballot systems also satisfy this requirement. However, this requirement is currently violated by mail-in and absentee ballots which necessarily must accompany identifiable information to be accepted as valid and legal.

The severability requirement is herein ignored. As of October 2020, twenty five US states allow an elector to disclose their ballot to third parties (usually in the form of a “selfie” on social media). If a state recognizes a right for an elector to disclose their vote, this system and method will not prevent an elector from doing so.

Significant challenges arise when enforcing equality. An election is a massive event requiring the cooperation of many workers distributed across vast geographic regions. Any one of these workers can accidentally or intentionally misplace or destroy ballots. A malicious actor can inject additional invalid ballots, or replace valid ballots with invalid ones. Voter ID laws can help to combat attacks on equality by electors, but they don't effectively prevent injection of illegal ballots by other malicious actors (e.g, dishonest poll workers or election software companies). Most ballots (paper and electronic) are highly susceptible to these kinds of attacks.

Finally, it is instructive to estimate what constitutes a system which requires no faith. For modern elections, it is impossible for every elector to observe the entirety of the chain of custody. When dealing with paper ballots, this leaves the vast majority of electors with no provable confidence in their ballot being accurately tallied. Further, even if a single elector observes the entire chain of custody of their individual ballot, no elector can be given reasonable evidence that equality is satisfied in general. All existing electronic systems similarly leave the elector with no reasonable evidence. A single bad actor can break equality.

Faith is a difficult quality to evaluate due to its subjectivity. The traditional ballot box, itself a completely open process, still requires some minutia of faith. A talented magician could likely cheat the process. Even cryptography is not perfectly secure. Passwords can be guessed, rainbow tables computed, backdoors built, or worse—the mathematical foundations themselves could be found exploitable. Encryption is built upon what is believed to be sufficiently difficult problems. Cracking cryptography is merely difficult enough to inspire faith, as is evidenced by online banking or the trillion dollar cryptocurrency market capitalization.

### SUMMARY OF THE INVENTION

The present invention comprises a system and method of casting an electronic ballot in an election whereby an elector retains a token which can be used to identify said ballot within a database. The present invention is designed such that any programming-capable individual is able to verify all election data and discern the results of an election independently, as well as detect fraud that may have taken place. The present invention further opens a substantial amount of the election process to the general public through the use of mobile and/or smart device applications which can be audited by third-parties.

### BRIEF DESCRIPTION OF DRAWINGS

Some embodiments of the present invention are illustrated as an example and are not limited to the figures of the accompanying drawings, in which like references may indicate similar elements and in which:

FIG. 1—FIG. 1 depicts the physical hardware connections between the system's computing devices in the preferred embodiment.

FIG. 2—FIG. 2 illustrates the preferred embodiment for validating a ballot machine.

FIG. 3—FIG. 3 illustrates the preferred embodiment for validating an elector before the elector fills out a ballot.

FIG. 4—FIG. 4 illustrates the preferred embodiment of packaging ballot information in preparation for transmitting it to a validation computing device.

FIG. 5—FIG. 5 depicts the structure of data for a ballot that is ready to be transmitted for validation.

FIG. 6—FIG. 6 illustrates the preferred embodiment for validating an elector's ballot before accepting it into the final ballot database.

FIG. 7—FIG. 7 depicts the preferred embodiment of validating a ballot receipt and auditing the authenticity of a single ballot.

FIG. 8—FIG. 8 depicts the preferred embodiment of the entire method of generating and validating a ballot that is expanded upon in FIGS. 3, 4, and 6.

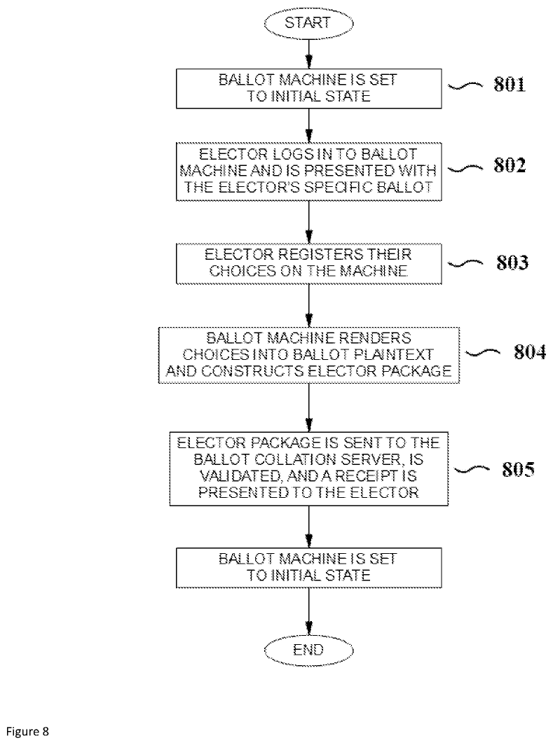

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New election systems are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

Digital signatures can provide proof of ownership with regard to strings of data. They also provide proof that said strings of data have not changed. This is perfect for digital ballots. An elector's ballot can be rendered into a pre-defined, plaintext format (XML, etc) and then signed by said elector's unique, ephemeral private key. The ballot plaintext, public key, and signature comprise the elector's ballot package. The elector then sends their ballot package to a central ballot server where it is validated and stored. At the conclusion of an electoral period, the collated database is released publicly for any interested party to compute the results of an election. Any interested elector could verify their ballot is included in the database by simply retaining their ballot signature and private signing key at the time of voting and search for it in the database. If the associated ballot plaintext matches the signature and key, the elector has some degree of proof their ballot hasn't changed from its casting.

Using cryptography in this manner satisfies only part of one characteristic of a secure election: Equality. It somewhat begins chipping away at the amount of faith required from an elector. By retaining a token, provided it can be shown to be unique, the elector can be certain their true vote is being counted toward the final tally. Their vote cannot be altered or destroyed without detection.

A secure election system must also prevent unauthorized ballots from being added to the database (stuffing the box). The simplest solution to the remaining equality problem is requiring a biometric token from an elector before a ballot will be accepted for collation. Requiring a biometric token effectively ties a ballot to a body. A biometric seed is used to generate a unique public-private keypair associated with a particular human body. The public key is stored in a voter registration database. The private key is only used (and promptly discarded) when signing a piece of data (such as a challenge) to prove an authorized body is associated with a sanctioned action—such as casting a ballot in an election. This type of design prevents a third party from “stuffing the ballot” by requiring information for which a third party has no access. Further, even if a malicious actor has unrestricted access to the registration database, the nature of the key generation limits the number of entries said malicious actor can create and actually use. As an additional benefit, using biometrics side-steps the controversial issue of voterID since no state-issued materials need to be presented to vote—the elector's body serves as positive identification. While no known method exists to generate cryptographic keys from biometrics, an alternative must be used. Additionally, not all jurisdictions may decide biometrics are justifiable due to privacy concerns. In such instances, a suitable alternative can be used such as mailing a machine-readable signing private key to electors through postal mail to an authorized residential address.

The described system would satisfy the equality requirement, so long as the method of biometric key generation can be enforced. If an attacker has unrestricted access to the voter registration database, and can run custom code to generate signed ballots with purported (but not actual) biometric keys, the ballot server will be unable to discern between legal ballots and stuffed ballots. Here, Hardware Security Modules (HSM) are useful. Authorized (white-listed) ballot machines can be manufactured, leveraging embedded HSM keys as proof of identity. The operating code for the ballot machine can be encrypted with the HSM (such as with LUKS on Linux) to help restrict access and tampering when deployed in the field. Any electronic ballot package arriving at the ballot server must be signed by a previously known and authorized HSM in order to be trusted as valid. Such a system can enforce biometric generation of cryptographic keys used for identification of electors. The HSMs and attached hardware may be available to third party audit to ensure no HSM has been added to the white-list which is not configured as an authentic ballot device. Such a whitelist must be published and publicly audited prior to and/or immediately after use.

Equality is not solely maintained in relationship between the ballot server and the elector, but also necessarily between electors. If an elector cries foul and insists a ballot has been deleted from the publicly released election results, all other electors must be capable of testing the claim. As the software for such a system must be open-source, any programmer could download the code to understand the data format and cryptographic functions used to generate ballots. Said programmer could then generate a ballot and signature on unsanctioned hardware with no HSM and falsely claim the ballot signature should be in the database. Employing election authority signing keys solves this problem. If the ballot server maintains a signing keypair, and releases the public key before an election, the server can use the keypair to sign ballot signatures which have been legitimately submitted. In doing so, a third party can test deletion allegations by checking if the retained ballot signature has itself been signed by the election authority. A ballot signature, further signed by the ballot server, is herein referred to as a ballot receipt. It serves as proof to any party that a ballot with a specific signature has been received by the collation server and must be present in the publicly auditable database released at the conclusion of any election.

By employing a central authority to sign ballots, it becomes necessary for a ballot device to transmit ballot data to a remote server. It is universally undesirable to connect sensitive computational devices to a network—especially the internet. But the ballot machines are required to transmit a packet of information across the internet to a server, and expect a response. Fortunately, this does not require a network connection and can be accomplished on hardware devoid of traditional networking capabilities. A ballot machine (a secure device) can be connected to a network-facing, unsecure device through a custom chip interface. Alternatively, general-purpose IO pins can be driven by purpose-specific software. Data can be transferred across these pins by setting the voltage high or low, and reading the pin voltage on the connected device. This is informally known as bit-banging. Tightly controlling access to and parsing of the data transmitted across the GPIO restricts the ability of an attacker to compromise the system, with the network-facing device acting as a firewall. The elector envelope can therefore be securely bit-banged across a bus to the (presumed unsecure) network-facing device, without any other data being capable of passing through. Specifically, when not sending and receiving data, the ballot machine is deaf to the GPIO. In situations where ballot devices must remain entirely isolated from all networking, an HSM signature may suffice in place of a ballot server signature.

Prior to an election, relevant data must be generated in preparation for public release. A relevant set of examples are listed below, with the associated benefits.

When employing biometrics, biometrically derived public signing keys must be gathered from electors. Releasing the public keys prior to an election cements the number of electors and adds constraints on stuffing-the-box. Private keys must be generated and used on secure hardware and promptly deleted after begin used for an identity function (such as generating a public key or signing a challenge).

When not employing biometrics, a private signing key must be generated and sent to each elector in a secure manner. Employing physical mail, such as the USPS, adds a minimal identity check by requiring a valid postal address in order to receive a key. This cements the number of electors and adds a minimal constraint on stuffing-the-box.

A signing keypair is generated for the election authority, with the public signing key being released. This is to allow the election authority to sign data and the public to verify said data has originated from the election authority.

The hardware security module public signing keys are released for all ballot machines authorized to be used during the election. This allows any interested party to identify unauthorized hardware being used in an election.

The addresses of valid polling locations are released, giving any interested party the ability to visit any location to observe hardware. A list of valid ballot machines (with the associated HSM public keys) is given for each polling location. This grants any interested party the ability to identify misplaced hardware, such as invalid hardware being in the field, or valid hardware being absent.

All open contests and the candidates for said contests are released, preventing candidate id numbers from being swapped or names/titles/party affiliation from being changed.

It is of general interest for third-parties to use this data to host auditing services during and after the election. With access to mobile smart devices and third-party applications, any interested party is capable of downloading auditing software. By referencing the authority-published data released prior to the election, any interested party gains three valuable abilities during the election as described below.

Any elector has the ability to audit their signing key. Doing so will confirm if an elector's signing key has been used to submit a ballot. The app can pull key bytes from the machine-readable code or biometrics, and if used, can report the challenge bytes and signature associated with the key.

Any observer has the ability to audit a ballot machine. Since the election software is open-source, an unauthorized machine can easily be made to impersonate an authentic one. Detecting the subterfuge requires a cryptographic challenge. Each ballot machine presents its HSM public signing key to be read by an auditing app (e.g, by machine readable code). The app reads the ballot machine's HSM public key and checks the list of authorized HSM public keys released before the election. If the key exists in the database, the app generates 64 random bytes of challenge data. The challenge data is transmitted to the ballot machine (optically or otherwise) and the ballot machine's HSM signs the challenge data with its private signing key. The signature is presented to the app for reading. The app then confirms the signature matches the challenge data and the reported HSM key. Any errors are reported to the user, allowing the issue to be contested and corrected immediately.

Any observer with access to a ballot receipt can audit said ballot receipt. Perhaps the most critical function to satisfying zero-trust is giving an elector the immediate ability to verify their vote is both counted and unchanged. When receiving a machine-readable receipt upon casting a ballot, signed by a central collation server with access to the election authority key, an elector can immediately be assured their vote is both counted and unadulterated.

The present invention will now be described by referencing the appended figures representing a preferred embodiment.

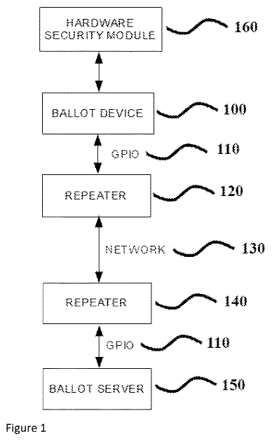

FIG. 1 is a diagram schematically illustrating the connection between relevant machines in an embodiment of the present invention. A ballot device 100 allows a user to register their preferences in an election and encodes it into a standardized format. The ballot device 100 must transmit and receive data from a remote ballot server 150 which authenticates an elector's identity, keeps record of the contests in which an elector may participate, and stores an elector's completed ballots. The network 130 through which the ballot device 100 must communicate is considered to be hostile and not secure. As such, the ballot device 100 is isolated from the network 130 by using a repeater 120. The repeater 120 is connected to the ballot device 100 through a GPIO 110 or other similarly constrained instruction set which prevents network users from attempting to log in to the ballot device 100 or otherwise send it unsecure commands. The ballot server 150 is optionally also isolated using a repeater 140.

An elector arrives at a polling location and chooses a ballot machine on which to cast a ballot. Optionally, the elector has the ability to verify the identity of any ballot machine and that the machine is authentic for the purposes of the election. An elector is greeted by a welcome screen on the ballot device. On the screen exists a machine-readable code such as a QR code. Alternatively, a different embodiment may use RFID or another technology that allows a user to definitively identify the source of the data. When utilizing an optical communication media (such as machine-readable codes), a button exists on screen which the user may touch to enable a camera to be used to read said codes.

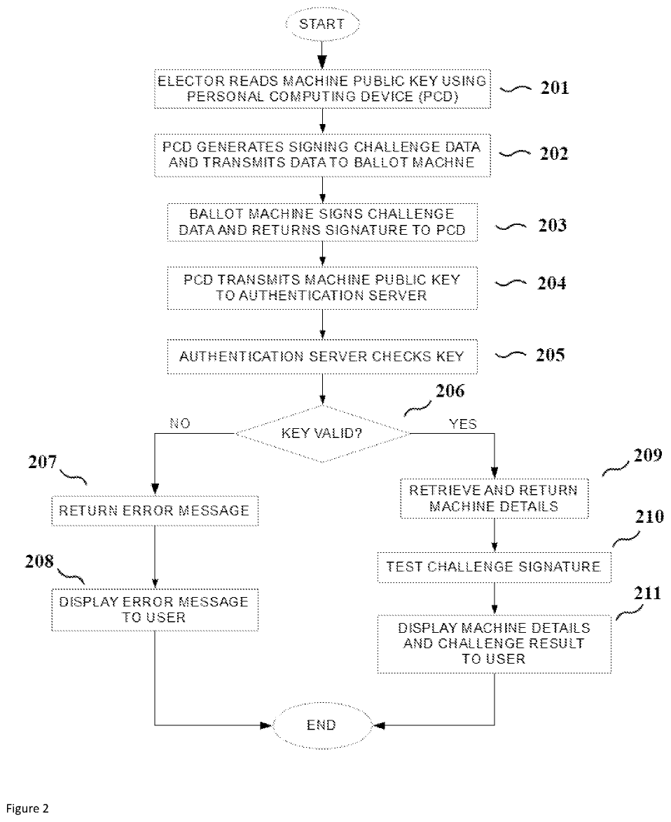

The process to validate a ballot machine is depicted in FIG. 2. If the elector chooses to verify the ballot machine is authentic, the elector uses a personal computing device (PCD), such as a smart phone, to retrieve 201 the ballot machine's HSM public signing key. In the current embodiment, that involves scanning a QR code present on the ballot machine's welcome screen. The elector's PCD generates 202 a signing challenge in the form of random bytes of data and transmits the challenge to the ballot machine. In the current embodiment, that takes the form of generating and displaying a QR code on the PCD screen that can be optically scanned by the ballot machine. The ballot machine then uses its HSM to sign 203 the challenge data and return the data to the elector's PCD. Returning the data is accomplished by updating the QR code on the ballot machine and allowing the elector to scan it. The elector's PCD transmits 204 the ballot machine's HSM public key to an authentication server. The authentication server checks 205 the HSM public key against a database of valid machine keys. This database is the same, or a copy of, the database of valid machine keys released publicly before the start of the election. If the HSM key does not exist in the database, the authentication server returns 207 an error message to the elector's PCD, and the PCD then displays 208 the error message or otherwise informs the elector that the machine key is invalid. If the HSM key does exist in the database, the authentication server retrieves 209 extra details about the assigned machine and returns the information to the elector's PCD. These extra details include the name and location of the intended deployment of the machine associated with the HSM key. The elector's PCD tests 210 the challenge signature to ensure it is valid in relation to the challenge data and the scanned HSM public key. The PCD then displays 211 the machine's intended deployment location, as well as whether the challenge data was successfully signed. This process allows an elector to validate the authenticity of any ballot machine deployed in the field, as well as verifying it was deployed to the correct polling location.

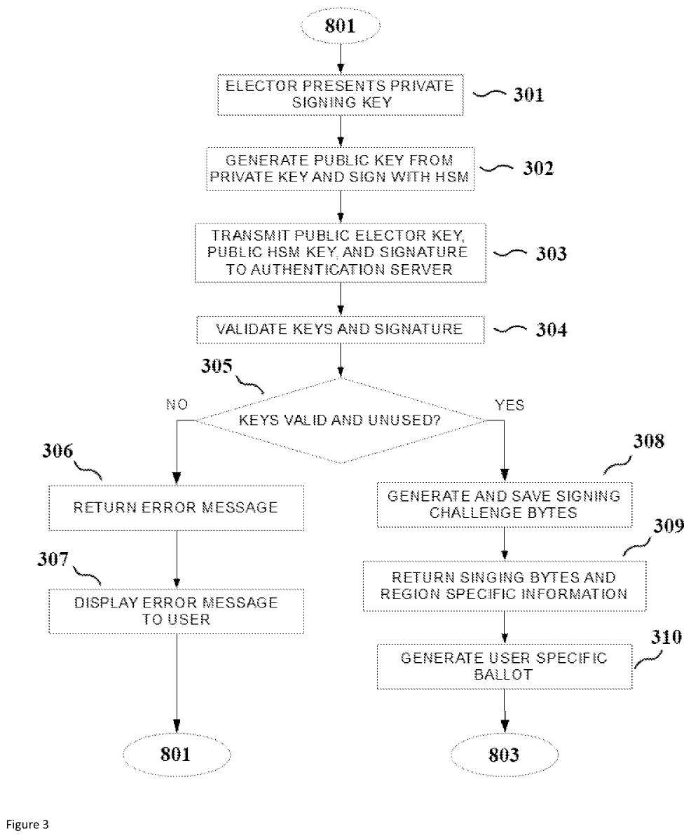

The elector sign-in process 802 is depicted in FIG. 3. The elector presents their identification token to the ballot machine in 301. According to the present invention, the identification token is a physically mailed machine readable code (such as QR) that contains a private signing key. The ballot machine computes 302 the elector's public key from their private key and signs the public key with the HSM. The signature, elector public key, and HSM public key are sent 303 to an authentication server by means of the repeater 120. The authentication server validates 304 the keys by searching the database released before the start of the election. If the HSM public key exists in the list of whitelisted ballot machines, it is presumed to be a valid HSM key. If the elector public key exists in the database of elector keys, it is presumed to be a valid elector key. The elector key must also be unused. The signature of the elector public key must also match the HSM public key. If any of these checks fail, the server returns 306 an error message to the ballot machine and the ballot machine displays 307 an error to the user. If all checks pass, the authentication server generates 308 random bytes to be issued as a signing challenge to the elector. These bytes are stored in association with the elector's public key in the voter roll. The server retrieves the elector's region-specific data from the database and returns 309 the signing challenge bytes and region data to the ballot machine. The ballot machine then uses the region-specific data to generate 310 a ballot containing all contests in which the elector is eligible to vote, and displays said ballot to the elector.

The elector then uses the ballot machine to register their choices 803 on the displayed ballot. When finished, the elector is presented their completed ballot for approval or revision. The elector can make changes, or accept the ballot as final.

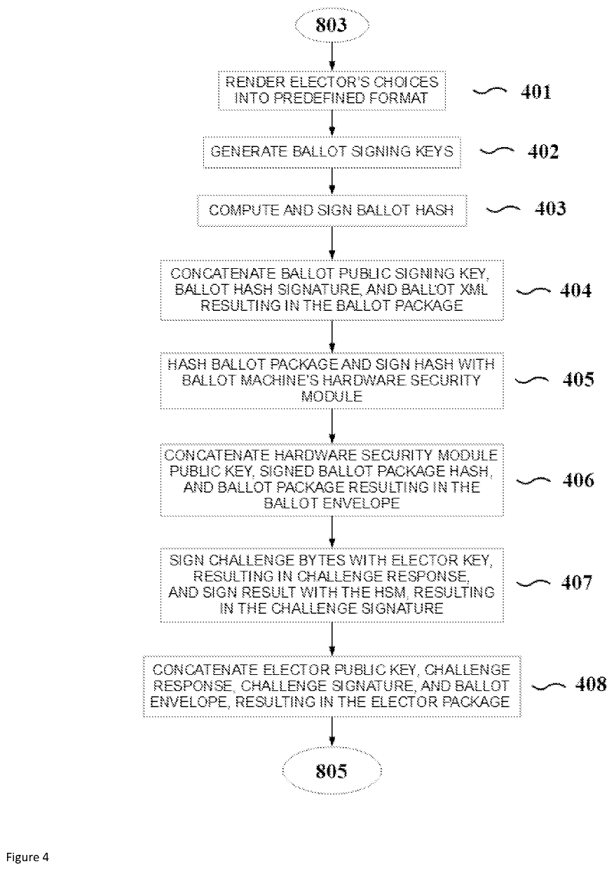

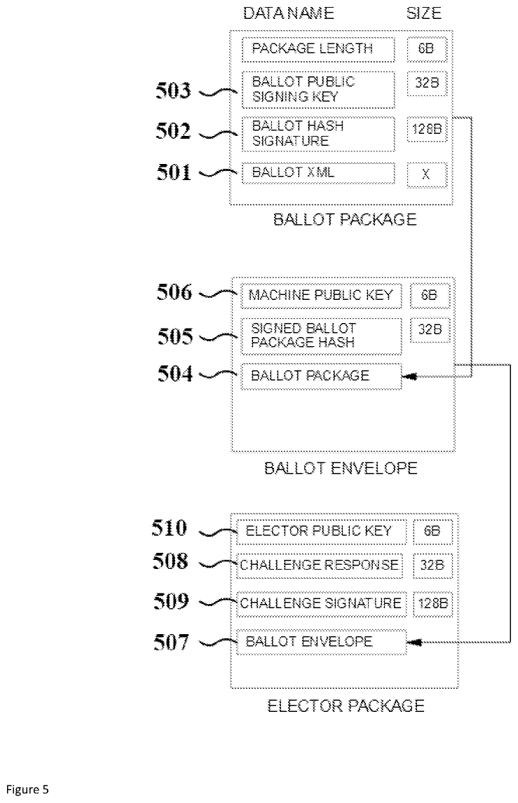

The method of finalizing a ballot 804 is depicted in FIG. 4, which results in a data structure depicted in FIG. 5. The ballot machine first renders 401 the electors choices into a predefined human-readable format 501. The preferred method uses XML, and includes the selected candidate names, titles, and party affiliations. Candidate information is rendered into the ballot in a human-readable fashion in order to further discourage candidate indices or information from being swapped in the database. Write-in candidate names are simply stored as entered. The ballot machine generates 402 a one-time-use signing keypair (ballot key) to be linked to the ballot. The ballot XML is hashed 403, and the resulting hash is signed by the ballot private key, resulting in the ballot hash signature 502. The ballot hash signature and ballot key provides proof that a matching ballot XML should exist in the ballot database. This renders a submitted ballot immutable and unable to be deleted. Rendering the private ballot key to an elector serves as proof-of-ownership. The ballot public key 503, ballot hash signature 502, and ballot XML 501 are concatenated 404, resulting in the ballot package 504.

The ballot collation server must enforce chain-of-custody for submitted ballots. As such, the submitted ballot must contain proof of origin from an authentic ballot machine. To provide said proof, the ballot package is hashed 405, and the resulting hash is signed by the ballot machine's HSM, resulting in the signed ballot package hash 505. The HSM public key 506 must then accompany the ballot package and signed ballot package hash in order to prove chain-of-custody. The HSM public key 506, signed ballot package hash 505, and ballot package 504 are concatenated 406 resulting in the ballot envelope 507.

The ballot collation server must also enforce equality by requiring proof of elector identity when receiving a ballot. To retain anonymity, the proof of identity is severed from the ballot upon receipt at the collation server. The ballot machine uses the elector private key to sign 407 the challenge data received from the authentication server when the elector logged in, which results in the challenge response 508. The challenge response proves the user submitting the ballot possesses the elector's private signing key, providing proof of identity. Since the identity challenge must be severed from the ballot, proof-of-origin must be rendered for the identity challenge as well as the ballot. Therefore, the challenge response is signed by the ballot machine's HSM, resulting in the challenge signature 509. The elector public key 510, challenge response 508, challenge signature 509, and ballot envelope 507 are concatenated 408, resulting in the elector package.

The requirement of data signed by the collation server (namely, the receipt) forces a situation where the elector's package must be sent over an untrusted network in real-time. This allows the elector to acquire and retain a receipt at the time of casting a ballot. In preparation for this, the ballot machine must encrypt the elector package such that it cannot be read or altered by a man-in-the-middle. An ephemeral “transmission” keypair is generated to encrypt the elector package. A published server public encryption key is used with the private transmission key to compute a common symmetric encryption key that is used to encrypt the elector package. The resulting cipher is concatenated with the transmission public key and the used nonce, resulting in the final elector envelope. Said envelope is sent to the collation server using the GPIO attached network-facing device. In the absence of an internet connection, another piece of trusted hardware can be used to sign a ballot. This could be a network device which exists to store ballots when an internet connection is not available, or the ballot machine itself by leveraging the embedded HSM.

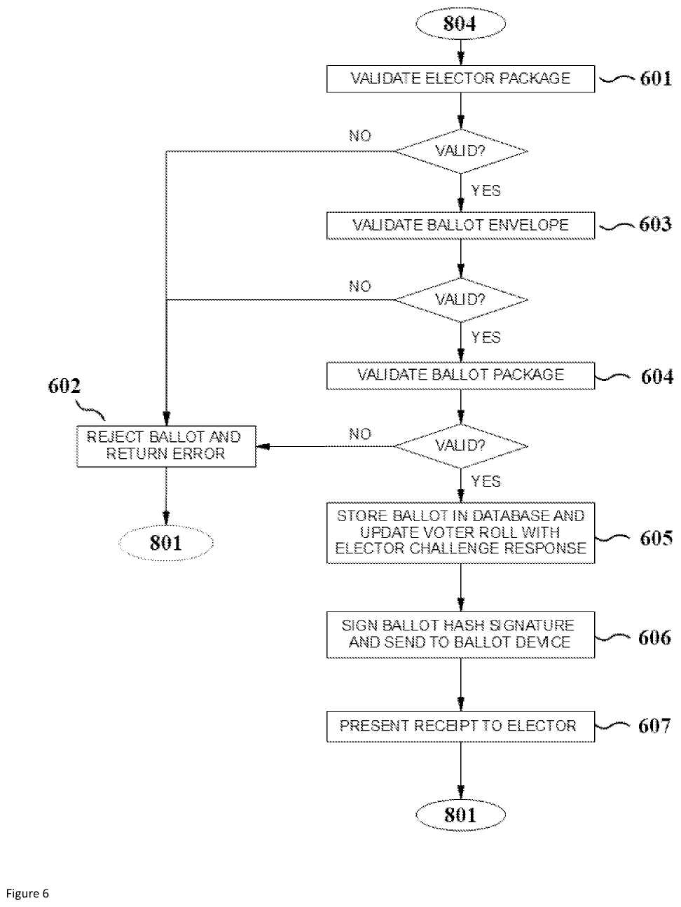

The process of validating the elector package server-side 805 is depicted in FIG. 6. Once received by the collation server, the elector envelope is separated into it's constituent parts, and the elector package cipher is decrypted. The elector package is then validated 601. Validation of the elector package requires checking that the elector's public key 510 exists in a whitelist of legal electors. The package is rejected 602 if the key is not found or was previously used. A rejection results in an error message being returned to the ballot machine and displayed to the user. The ballot machine then resets allowing for another elector login. If the elector key is valid and unused, then the challenge response 508 is validated against the elector public key 510 to prove the elector's identity. Failure results in an error message returned 602 to the ballot machine and a machine reset. The challenge signature 509 is validated against the HSM public key 506 in order to prove chain-of-custody and show the elector signing challenge was completed on a valid ballot machine. Failure results in an error message returned 602 to the ballot machine and a machine reset.

If the elector package is valid, then the ballot envelope is validated 603: The ballot package 504 is separated and hashed, and that hash is checked against the signed ballot package hash 505 and the HSM public key 506. If the signature is valid, the HSM public key is checked against the whitelist. If the key exists in the whitelist, the ballot package is confirmed to have come from a trusted machine and therefore represents a ballot cast by an actual elector. Failure of any of these checks results in an error message returned 602 to the ballot machine and a machine reset.

If the ballot envelope is valid, then the ballot package is validated 604. The ballot XML 501 is hashed and checked against the ballot public signing key 503 and ballot hash signature 502. If valid, the signature proves the ballot XML hasn't changed from the elector's casting. The contests listed in the elector's ballot XML are then checked against the elector's location information to ensure the elector hasn't voted in a contest in which they are not eligible to vote. Further, each candidate the elector has selected for each contest is checked to ensure the candidate is a valid choice for the designated contest, and the candidate's name, title, party affiliation, and candidate ID number are correctly represented in the XML. Failure of any of ballot envelope checks results in an error message returned 602 to the ballot machine and a machine reset.

If all checks are valid, the elector's ballot XML 501, the ballot hash signature 502, the ballot public signing key 503, the machine HSM public key 506, and the signed ballot package hash 505 are stored 605 as a single entry in a ballot database, herein referred to as a ballot record. The voter roll is updated to include the elector's challenge response 508 and the challenge signature 509 that was created by the HSM. The ballot hash signature 502 is signed 606 to provide proof of ballot receipt by the collation server. The signed ballot hash signature is returned to the ballot machine.

The ballot machine concatenates the ballot private signing key and the signed ballot hash signature, resulting in the ballot receipt. The receipt is then presented 607 to the elector by encoding it into a QR code and displaying it on screen. The elector is given the choice to print a physical copy of the ballot receipt. The elector may also opt for a receipt encoded as an alphanumeric string, such that the data is human-readable. If a physical receipt is not printed, the elector may alternatively scan the QR code directly from the ballot machine's screen using a PCD. Possession of the ballot private signing key is considered proof-of-ownership of the submitted ballot, while possession of the signed ballot hash signature proves the collation server accepted a ballot package that contained the ballot hash signature. If the elector's ballot XML 501 is changed, then the ballot hash signature 502 will no longer match the ballot XML, and the elector will be able to prove the error. The ballot hash signature cannot be changed without using the ballot private signing key. If the ballot public signing key is changed such that a change to the ballot hash signature and ballot XML is undetectable, it will leave the elector holding a ballot private key with no associated public key that exists in the ballot database. The elector will then be able to prove their ballot was tampered or deleted by presenting their signed ballot hash signature. When the signed ballot hash signature can be unsigned by the election authority public key, it proves the ballot hash signature must exist in the ballot database. After retaining the ballot receipt, the elector can then exit their session, destroying all user variables and returning the ballot machine to a welcome screen (prompting for elector sign-in).

At the close of the election, all databases are released with the exception of the private election authority keys. This allows all interested parties to audit their own receipts. While services and apps can be set up to help computer illiterate electors to scan and check their votes, a completely transparent audit necessitates auditors who program their own software to perform cryptographic checks against the released databases. Vote totals and contest winners can be computed by any interested party by inspecting the released databases.

Any interested party may acquire the completed and official ballot database from the entity running the election. This could be through county website, the election company's FTP server, or a trusted peer-to-peer interface such as a signed torrent.

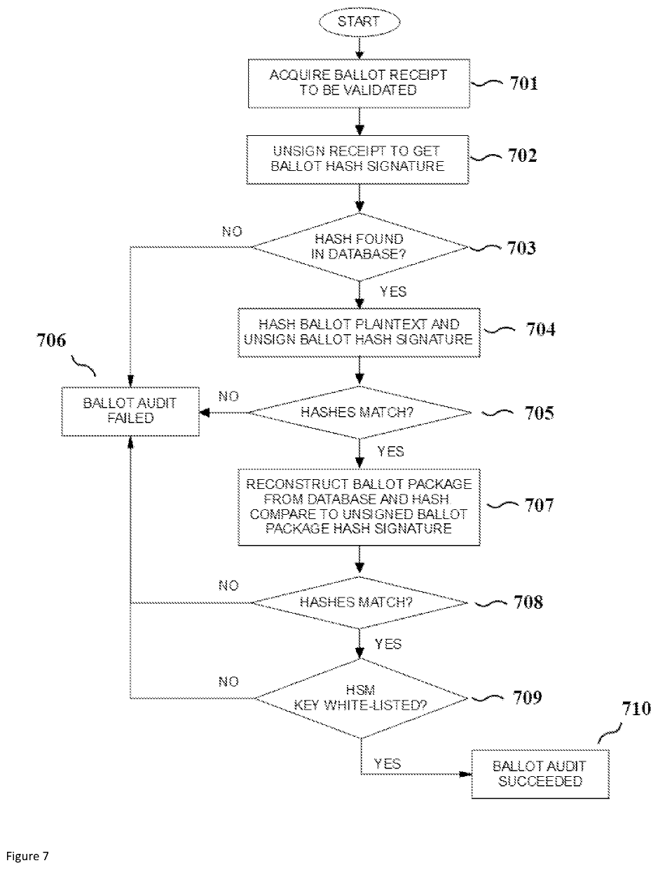

The ballot audit process is detailed in FIG. 7. For an acquired paper or digital ballot receipt, the machine readable code is scanned and unpacked 701 to bytes. The ballot receipt is unsigned 702 using the election authority public signing key. This results in the original ballot hash signature received by the server. The ballot hash signature is searched for 703 in the database. If missing, the audit fails 706 and the receipt should be reported to election officials and oversight organizations.

The ballot XML is hashed 704 and the ballot hash signature is unsigned with the associated elector's public key. If the hashes don't match in 705, the audit process fails 706. The ballot package is then reconstructed 707 by concatenating the elector's public signing key, the elector's ballot hash signature, the ballot plaintext, and the length of the resulting concatenation (the length being placed at the beginning). The package is hashed and compared 708 to the un-signed ballot package hash signature (having been un-signed with the associated HSM key). If the hashes don't match in 708, the audit process fails 706. The associated HSM key is checked 709 against the HSM whitelist released before the start of the election to ensure it is a legal key. If the key doesn't exist in the whitelist, the audit process fails 706. If the HSM key is found, the ballot audit has succeeded 710.

The ballot database itself can be audited in full without requiring a paper ballot receipt. The paper ballot receipt allows an elector to retrieve and audit their ballot, with the additional step of confirming that the ballot plaintext matches their selections cast at the ballot machine. Performing a general audit obviously loses that extra plaintext confirmation, but the cryptography and HSM usage constrains bad actors from tampering with the ballot data. For a general audit, the process outlined in FIG. 7 is performed on every ballot entry present in the database, with the difference that the process starts at 702 by retrieving a ballot hash signature from the database directly instead of from an elector's receipt.

In addition to allowing any elector to audit various functions in an election real-time, using a PCD allows an elector to maintain a record of their voting history. By storing ballot receipts in a PCD rather than on a physical media, the elector may also retain control over their privacy by password-protecting the PCD or the ballot receipts therein.

Leveraging PCDs in an election system also allows electors to restore corrupted records. An elector who scans a ballot receipt from a ballot machine is capable of using the PCD to perform a ballot audit in real-time. After scanning the ballot receipt, the elector's PCD contacts the ballot collation server and requests a copy of the ballot record, which is transferred to the elector's PCD. Due to the hashes and signatures contained within the ballot record, the ballot record contains cryptographic proof that the contained ballot XML should be present in the ballot database. If a ballot record in the ballot database is corrupted (cryptographic checks fail) or missing, an elector can use their PCD to transmit their stored ballot record to the collation server in order to restore their ballot record. As such, utilizing PCDs in an election effectively distributes copies of ballot records to numerous, independently controlled devices controlled by individuals with a personal interest in maintaining a correct record.

Since the ballot record contains no personally identifiable information, the PCD can transmit that record to a third-party server that is designed to offer auditing and restoration services. At the close of an election, the third-party services can download the final ballot database and check it against the ballot records they have collected. If any corrections need be made, the services can contact the election authority with said corrections, while simultaneously alerting the local government and election oversight organizations of probable fraud. Should the services share their collected data, they may also be able to statistically identify probable sources of said fraud. Designing elector-owned mobile devices into the method effectively decentralizes election results such that no single entity can control the outcome without the possibility of correction.

1. A method of conducting a publicly auditable election comprising:
converting an elector's completed ballot into a predefined format;
cryptographically signing said formatted ballot with the private key of an asymmetric signing key pair, said key pair being retained by the elector;
cryptographically signing with a cryptographic processor the signature of the formatted ballot; and
making available to the elector the cryptographic processor's signature of the formatted ballot's signature.

2. The method of claim 1 wherein the predefined format is XML.

3. The method of claim 1 wherein the cryptographic processor is a hardware security module.

4. The method of claim 1 wherein the cryptographic processor is a trusted platform module.

5. The method of claim 1 wherein making available to the elector includes allowing the elector to physically print a machine-readable code containing the data to be made available.

6. A system to conduct a publicly auditable election comprising:
at least one computing device configured to:
convert an elector's completed ballot into a predefined format;
cryptographically sign said formatted ballot with the private key of an asymmetric signing key pair;
make available to the elector a cryptographic processor's signature of the formatted ballot's signature.
a cryptographic processor configured to:
cryptographically sign data with an asymmetric signing key.

7. The method of claim 6 wherein the predefined format is XML.

8. The method of claim 6 wherein the cryptographic processor is a hardware security module.

9. The method of claim 6 wherein the cryptographic processor is a trusted platform module.

10. The method of claim 6 wherein making available to the elector includes allowing the elector to physically print a machine-readable code containing the data to be made available.

11. A method of conducting a publicly auditable election comprising:
converting an elector's completed ballot into a predefined format;
cryptographically signing said formatted ballot with the private key of an asymmetric signing key pair, said key pair being retained by the elector;
signing said formatted ballot's signature with a cryptographic processor;
transmitting to a server the formatted ballot, the formatted ballot's signature, the public key of the signing key pair retained by the elector, an identifying characteristic of the cryptographic processor, and the cryptographic processor's signature of the formatted ballot's signature;
signing the formatted ballot's signature with the private key of an asymmetric signing key pair, said key pair being maintained by an authority conducting the election; and
transmitting the authority's signature of the formatted ballot's signature to a computing device such that the elector may receive said signature.

12. The method of claim 11 wherein the predefined format is XML.

13. The method of claim 11 wherein the cryptographic processor is a hardware security module.

14. The method of claim 11 wherein the cryptographic processor is a trusted platform module.

15. The method of claim 11 wherein the identifying characteristic of the cryptographic processor is the public portion of a signing key pair.

16. The method of claim 11 wherein the identifying characteristic of the cryptographic processor is an identifying value which exists in a relational database.

17. A system to conduct a publicly auditable election comprising:
at least one computing device configured to:
convert an elector's completed ballot into a predefined format;
cryptographically sign said formatted ballot with the private key of an asymmetric signing key pair, said key pair being retained by the elector; and
transmit to a server the formatted ballot, the formatted ballot's signature, the public key of the signing key pair retained by the elector, an identifying characteristic of the cryptographic processor, and the cryptographic processor's signature of the formatted ballot's signature.
a cryptographic processor configured to:
cryptographically sign data with an asymmetric signing key.
a server configured to:
sign a formatted ballot's signature with the private key of an asymmetric signing key pair, said key pair being maintained by an authority conducting the election; and
transmitting the authority's signature of the formatted ballot's signature to a computing device such that the elector may receive said signature.

18. The system of claim 17 wherein the predefined format is XML.

19. The system of claim 17 wherein the cryptographic processor is a hardware security module.

20. The system of claim 17 wherein the cryptographic processor is a trusted platform module.

21. The system of claim 17 wherein the identifying characteristic of the cryptographic processor is the public portion of a signing key pair.

22. The system of claim 17 wherein the identifying characteristic of the cryptographic processor is an identifying value which exists in a relational database.
